(19) United States
(12) Patent Application Publication
(10) Pub. No.: US 2005/0181277 A1
(43) Pub. Date: Aug. 18, 2005

(54) Positive electrode for nonaqueous electrolytic secondary battery and method of manufacturing the same as well as nonaqueous electrolytic secondary battery and method of manufacturing the same

(75) Inventors: Hideyuki Koga, Kobe-shi (JP); Masahide Miyake, Kobe-shi (JP); Masahisa Fujimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/052,907

(22) Filed: Feb. 9, 2005

(30) Foreign Application Priority Data
Feb. 13, 2004 (JP) JP2004-35855
Mar. 15, 2004 (JP) JP2004-72183

(51) Int. Cl. H01M 4/58; C01B 17/00

(52) U.S. Cl. 429/221; 429/231.95; 29/623.1; 429/231.1; 423/561.1; 423/511

(57) ABSTRACT

A nonaqueous electrolytic secondary battery capable of improving the operating cycle characteristic is provided. This nonaqueous electrolytic secondary battery comprises a positive electrode containing a positive electrode active material including LiₓFeS₂ (0≦x≦4), a negative electrode containing a material occluding and emitting lithium ions and a nonaqueous electrolyte, and the final discharge potential of the positive electrode is set to a prescribed level exceeding the minimum potential allowing discharge reaction expressed in the following formula (3):
FeS₂+xLi⁺→LiₓFeS₂ (3)

### BACKGROUND OF THE INVENTION

1. Field of the Invention

The present invention relates to a positive electrode for a nonaqueous electrolytic secondary battery and a method of manufacturing the same as well as a nonaqueous electrolytic secondary battery and a method of manufacturing the same, and more particularly, it relates to a positive electrode for a nonaqueous electrolytic secondary battery containing a positive electrode active material and a method of manufacturing the same as well as a nonaqueous electrolytic secondary battery and a method of manufacturing the same.

2. Description of the Background Art

A nonaqueous secondary battery charged/discharged by moving lithium ions between positive and negative electrodes through a nonaqueous electrolyte is generally known as a secondary battery having high energy density. In such a conventional nonaqueous electrolytic secondary battery, a lithium transition metal composite oxide such as LiCoO₂ is employed for the positive electrode while a lithium metal, a lithium alloy or a carbon material capable of occluding and emitting lithium. The nonaqueous electrolyte is prepared by dissolving an electrolyte consisting of lithium salt such as LiBF₄ or LiPF₆ in an organic solvent such as ethylene carbonate or diethyl carbonate. The conventional nonaqueous electrolytic secondary battery is used as the power source for various types of portable devices or the like. A nonaqueous electrolytic secondary battery having higher energy density is required in response to power consumption increased following multi-functionalization of the portable devices.

However, the lithium transition metal composite oxide such as LiCoO₂ employed for the positive electrode of the conventional nonaqueous electrolytic secondary battery has such a large mass and such a small reactive electron number that it is disadvantageously difficult to sufficiently increase the capacity (specific capacity) per unit mass.

In order to solve this problem, a technique of applying iron disulfide (FeS₂) capable of attaining high energy density to a positive electrode active material is proposed in general. This technique is disclosed in Japanese Patent Laying-Open No. 58-150269 (1983), for example. It is known that discharge reaction takes place in two stages when iron disulfide is applied to the positive electrode active material, as shown in the following formulas (1) and (2) (refer to non-patent literature 1, for example). In other words, the reaction shown in the formula (1) takes place at a voltage of about 2.0 V, and the reaction shown in the formula (2) takes place at a voltage of about 1.4 V.
FeS₂+2Li⁺→Li₂FeS₂ (1)
Li₂FeS₂+2Li⁺→2Li₂S+Fe (2)

J. Solid State Ionics, 117 (1999) by K. Takada, K. Iwamoto and S. Kondo, pp. 273-276 discloses a technique of employing Li₂FeS₂ as a positive electrode active material.

When applied to a positive electrode active material for a secondary battery, however, the aforementioned iron disulfide (FeS₂) or Li₂FeS₂ is separated into Fe and the insulator Li₂S due to the reaction shown in the above formula (2), to hardly allow charge function. Therefore, the operating cycle characteristic is disadvantageously reduced.

### SUMMARY OF THE INVENTION

The present invention has been proposed in order to solve the aforementioned problem, and an object of the present invention is to provide a nonaqueous electrolytic secondary battery capable improving the operating cycle characteristic.

Another object of the present invention is to provide a method of manufacturing a nonaqueous electrolytic secondary battery capable of easily manufacturing a nonaqueous electrolytic secondary battery capable of improving the operating cycle characteristic.

In order to attain the aforementioned objects, a nonaqueous electrolytic secondary battery according to a first aspect of the present invention comprises a positive electrode containing a positive electrode active material including LiₓFeS₂ (0≦x≦4), a negative electrode containing a material occluding and emitting lithium ions and a nonaqueous electrolyte, while the final discharge potential of the positive electrode is set to a prescribed level exceeding the minimum potential allowing discharge reaction expressed in the following formula (3):
FeS₂+xLi⁺→LiₓFeS₂ (3)

In the nonaqueous electrolytic secondary battery according to the first aspect, as hereinabove described, the final discharge potential of the positive electrode containing the positive electrode active material including LiₓFeS₂ (0≦=x≦4) is so set to the prescribed level exceeding the minimum potential allowing the discharge reaction expressed in the above formula (3) that the operating cycle characteristic of the nonaqueous electrolytic secondary battery can be improved. This is conceivably because LiₓFeS₂ can be prevented from separating into Fe hardly allowing charge reaction and the insulator Li₂S by stopping discharge of the nonaqueous electrolytic secondary battery during the discharge reaction expressed in the above formula (3) and hence charge reaction can be easily produced.

In the aforementioned nonaqueous electrolytic secondary battery according to the first aspect, LiₓFeS₂ (0≦x≦4) included in the positive electrode active material is preferably Li₂FeS₂, and the final discharge potential of the positive electrode is preferably set to a prescribed level exceeding the minimum potential allowing discharge reaction expressed in the following formula (4):
FeS₂+2Li⁺→Li₂FeS₂ (4)

According to this structure, LiₓFeS₂ can be prevented from separating into Fe hardly allowing charge reaction and the insulator Li₂S, whereby charge reaction can be easily produced. Thus, the operating cycle characteristic of the nonaqueous electrolytic secondary battery can be improved.

In this case, the final discharge potential of the positive electrode is preferably set to a level of at least about 1.5 V (vs. Li/Li⁺). According to this structure, LiₓFeS₂ can be effectively prevented from separating into Fe hardly allowing charge reaction and the insulator Li₂S, whereby charge reaction can be easily produced. Thus, the operating cycle characteristic of the nonaqueous electrolytic secondary battery can be improved. This effect has been proved by a comparative experiment described later.

In the aforementioned nonaqueous electrolytic secondary battery according to the first aspect, LiₓFeS₂ forming the positive electrode active material is preferably substantially amorphous. According to this structure, the operating cycle characteristic of the nonaqueous electrolytic secondary battery can be further improved as compared with a case of preparing the positive electrode active material from crystalline LiₓFeS₂.

A nonaqueous electrolytic secondary battery according to a second aspect of the present invention comprises a positive electrode containing a positive electrode active material including LiₓFeS₂ (0≦x≦4), a negative electrode containing a material occluding and emitting lithium ions and a nonaqueous electrolyte, while the final discharge potential of the positive electrode is set to a level of at least about 1.5 V (vs. Li/Li⁺).

In the nonaqueous electrolytic secondary battery according to the second aspect, as hereinabove described, the final discharge potential of the positive electrode containing the positive electrode active material including LiₓFeS₂ (0≦x≦4) is so set to the level of at least about 1.5 V (vs. Li/Li⁺) that LiₓFeS₂ can be effectively prevented from separating into Fe hardly allowing charge reaction and the insulator Li₂S, whereby charge reaction can be easily produced. Thus, the operating cycle characteristic of the nonaqueous electrolytic secondary battery can be improved.

In the aforementioned nonaqueous electrolytic secondary battery according to the second aspect, LiₓFeS₂ forming the positive electrode active material is preferably substantially amorphous. According to this structure, the operating cycle characteristic of the nonaqueous electrolytic secondary battery can be further improved as compared with a case of preparing the positive electrode active material from crystalline LiₓFeS₂.

A nonaqueous electrolytic secondary battery according to a third aspect of the present invention comprises a positive electrode containing a positive electrode active material including LiₓFeS_{y} (0≦x≦4, 0.5≦y ≦3), a negative electrode containing a material occluding and emitting lithium ions and a nonaqueous electrolyte, while the final discharge potential of the positive electrode is set to a prescribed level exceeding the minimum potential allowing discharge reaction expressed in the following formula (5):
FeS_{y}+xLi⁺→LiₓFeS_{y} (5)

In the nonaqueous electrolytic secondary battery according to the third aspect, as hereinabove described, the final discharge potential of the positive electrode containing the positive electrode active material including LiₓFeS_{y}(0≦x≦4, 0.5≦y≦3) is so set to the prescribed level exceeding the minimum potential allowing discharge reaction expressed in the above formula (5) that the operating cycle characteristic of the nonaqueous electrolytic secondary battery can be further improved as compared with a case of setting the final discharge potential of the positive electrode to a level allowing no discharge reaction expressed in the above formula (5). This is conceivably because LiₓFeS₂ can be prevented from separating into Fe hardly allowing charge reaction and the insulator Li₂S by stopping discharge of the nonaqueous electrolytic secondary battery during the discharge reaction expressed in the above formula (5) and hence charge reaction can be easily produced.

A method of manufacturing a nonaqueous electrolytic secondary battery according to a fourth aspect of the present invention is a method of manufacturing a nonaqueous electrolytic secondary battery comprising a positive electrode containing a positive electrode active material including LiₓFeS₂ (0≦x≦4), a negative electrode containing a material occluding and emitting lithium ions and a nonaqueous electrolyte, while the final discharge potential of the positive electrode is set to a prescribed level exceeding the minimum potential allowing discharge reaction expressed in the following formula (3), and comprises steps of forming the positive electrode containing the positive electrode active material including LiₓFeS₂ by heat-treating a mixture of Li₂S and FeS_{(2-x/2)} (0≦x≦4) and forming the negative electrode containing the material occluding and emitting lithium ions:
FeS₂+xLi⁺→LiₓFeS₂ (3)

In the method of manufacturing a nonaqueous electrolytic secondary battery according to the fourth aspect, as hereinabove described, the mixture of Li₂S and FeS_{(2-x/2)} (0≦x≦4) is so heat-treated that the positive electrode containing the positive electrode active material including LiₓFeS₂ can be easily formed.

A method of manufacturing a nonaqueous electrolytic secondary battery according to a fifth aspect of the present invention is a method of manufacturing a nonaqueous electrolytic secondary battery comprising a positive electrode containing a positive electrode active material including LiₓFeS₂ (0≦x≦4), a negative electrode containing a material occluding and emitting lithium ions and a nonaqueous electrolyte, and comprises steps of forming the positive electrode containing the positive electrode active material including substantially amorphous LiₓFeS₂ by mechanically milling a mixture of Li₂S and FeS_{(2-x/2)} (0≦x≦4) and forming the negative electrode containing the material occluding and emitting lithium ions.

In the method of manufacturing a nonaqueous electrolytic secondary battery according to the fifth aspect, as hereinabove described, the mixture of Li₂S and FeS_{(2-x/2)} is so mechanically milled that substantially amorphous LiₓFeS₂ can be easily formed.

A method of manufacturing a nonaqueous electrolytic secondary battery according to a sixth aspect of the present invention is a method of manufacturing a nonaqueous electrolytic secondary battery comprising a positive electrode containing a positive electrode active material including LiₓFeS₂ (0≦x≦4), a negative electrode containing a material occluding and emitting lithium ions and a nonaqueous electrolyte while the final discharge potential of the positive electrode is set to a prescribed level exceeding the minimum potential allowing discharge reaction expressed in the following formula (3), and comprises steps of forming the positive electrode containing the positive electrode active material including substantially amorphous LiₓFeS₂ by mechanically milling a mixture of Li₂S and FeS₍₂₋ₓ₂₎ (0≦x≦4) and forming the negative electrode containing the material occluding and emitting lithium ions:
FeS₂+xLi⁺→LiₓFeS₂ (3)

In the method of manufacturing a nonaqueous electrolytic secondary battery according to the sixth aspect, as hereinabove described, substantially amorphous LiₓFeS₂ is so formed by mechanically milling the mixture of Li₂S and FeS_{(2-x/2)} that the operating cycle characteristic of the nonaqueous electrolytic secondary battery can be further improved as compared with a case of forming crystalline LiₓFeS₂.

A positive electrode for a nonaqueous electrolytic secondary battery according to a seventh aspect of the present invention contains a positive electrode active material including a lithium-iron composite sulfide having a composition expressed in a composition formula LiₓFeS_{y} (2≦x≦4, 0.5≦y≦3) before initial charge.

In the positive electrode for a nonaqueous electrolytic secondary battery according to the seventh aspect, the value x in the composition formula LiₓFeS_{y} for the lithium-iron composite sulfide is so set in the range of 2≦x≦4 that a negative electrode active material poor in lithium can be employed in the nonaqueous electrolytic secondary battery formed with this positive electrode. Therefore, a short in the battery resulting from formation of the so-called dendrite (arborescent lithium) and reduction of the operating cycle characteristic as well as the battery voltage can be suppressed, and the battery capacity (particularly the initial capacity) can be increased. While the value y may be in the range of 0.5 to 3 for attaining the functions/effects of the present invention, this value is preferably set small in view of mass energy density.

In the aforementioned positive electrode for a nonaqueous electrolytic secondary battery according to the seventh aspect, preferably x≈4 and y≈2 in the lithium-iron composite sulfide expressed as LiₓFeS_{y}. According to this structure, a negative electrode active material containing absolutely no lithium can be employed in a nonaqueous electrolytic secondary battery formed with this positive electrode when x≈4, whereby a short in the battery and reduction of the operating cycle characteristic as well as the battery voltage can be further suppressed, and the battery capacity (particularly the initial capacity) can be further increased.

In the aforementioned positive electrode for a nonaqueous electrolytic secondary battery according to the seventh aspect, the positive electrode active material preferably contains an amorphous portion before initial charge. According to this structure, the operating cycle characteristic of a nonaqueous electrolytic secondary battery formed with this positive electrode for a nonaqueous secondary battery can be further improved as compared with a nonaqueous electrolytic secondary battery employing a generally used crystalline positive electrode active material.

A method of manufacturing a positive electrode for a nonaqueous electrolytic secondary battery according to an eighth aspect of the present invention comprises steps of preparing a mixture of at least either Fe or FeS and at least one material selected from a group of Li₂S, Li and S (S is not solely employed) and preparing a positive electrode active material including a lithium-iron composite sulfide expressed in a composition formula LiₓFeS_{y} (2<x≦4, 0.5≦y≦3) by mechanically milling the mixture.

In the method of manufacturing a positive electrode for a nonaqueous electrolytic secondary battery according to the eighth aspect, as hereinabove described, the mixture of at least either Fe or FeS and at least one material selected from the group of Li₂S, Li and S (S is not solely employed) is so mechanically milled that the lithium-iron composite sulfide expressed in the composition formula LiₓFeS_{y} (2<x≦4, 0.5≦y≦3) can be easily prepared. The lithium-iron composite sulfide prepared by mechanical milling contains a large quantity of amorphous portions, whereby a battery exhibiting an excellent discharge characteristic also in initial discharge can be formed while the operating characteristic can be improved when the positive electrode containing the positive electrode active material including this lithium-iron composite oxide is applied to a nonaqueous electrolytic secondary battery.

In the aforementioned method of manufacturing a positive electrode for a nonaqueous electrolytic secondary battery according to the eighth aspect, the step of preparing the mixture preferably includes a step of mixing Fe and Li₂S with each other at a molar ratio of about 1:2, and the step of preparing the positive electrode active material preferably includes a step of preparing the positive electrode active material including the lithium-iron composite sulfide expressed in the composition formula LiₓFeS_{y} (x≈4, y≈2) by mechanically milling the mixture. According to this structure, a negative electrode active material containing absolutely no lithium can be employed when preparing a nonaqueous electrolytic secondary battery with the positive electrode containing the positive electrode active material including the lithium-iron composite sulfide having the value x set to x ≈4. Therefore, a short in the battery resulting from formation of the so-called dendrite (arborescent lithium) and reduction of the operating cycle characteristic as well as the battery voltage can be suppressed, and the battery capacity (particularly the initial capacity) can be increased.

A nonaqueous electrolytic secondary battery according to a ninth aspect of the present invention comprises a positive electrode containing a positive electrode active material including a lithium-iron composite sulfide having a composition expressed in a composition formula LiₓFeS_{y} (2≦x≦4, 0.5≦y≦3) before initial charge, a negative electrode containing a negative electrode active material capable of occluding and emitting lithium and a nonaqueous electrolyte.

In the nonaqueous electrolytic secondary battery according to the ninth aspect, as hereinabove described, the value x in the composition formula LiₓFeS_{y} for the lithium-iron composite sulfide included in the positive electrode active material is so set in the range of 2≦x≦4 that a negative electrode active material poor in lithium can be applied to the nonaqueous electrolytic secondary battery. Therefore, a short in the battery resulting from formation of the so-called dendrite (arborescent lithium) and reduction of the operating cycle characteristic as well as the battery voltage can be suppressed, and the battery capacity (particularly the initial capacity) can be increased. While the value y may be in the range of 0.5 to 3 for attaining the functions/effects of the present invention, this value is preferably set small in view of mass energy density.

In the aforementioned nonaqueous electrolytic secondary battery according to the ninth embodiment, preferably x≈4 and y≈2 in the lithium-iron composite sulfide expressed as LiₓFeS_{y}. According to this structure, a negative electrode active material containing absolutely no lithium can be employed for the nonaqueous electrolytic secondary battery when x≈4, whereby a short in the battery and reduction of the operating cycle characteristic as well as the battery voltage can be further suppressed, and the battery capacity (particularly the initial capacity) can be further increased.

In the aforementioned nonaqueous electrolytic secondary battery according to the ninth aspect, the positive electrode active material preferably contains an amorphous portion before initial charge. According to this structure, the operating cycle characteristic of the nonaqueous electrolytic secondary battery can be further improved as compared with a nonaqueous electrolytic secondary battery employing a generally used crystalline positive electrode active material.

In the aforementioned nonaqueous electrolytic secondary battery according to the ninth aspect, the negative electrode active material preferably contains either a carbon material or a silicon material. According to this structure, a short in the battery resulting from formation of a dendrite and reduction of the operating cycle characteristic as well as the battery voltage can be easily suppressed and the battery capacity (particularly the initial capacity) can be easily increased due to the negative electrode active material prepared from the carbon material or the silicon material containing no lithium. While the carbon material such as graphite or the silicon material can be employed for the negative electrode active material, a silicon material having large capacity is preferably employed in order to obtain a nonaqueous electrolytic battery having high energy density, as described in Japanese Patent Laying-Open Nos. 2001-266851 and 2002-083594 in the name of the applicant.

A method of manufacturing a nonaqueous electrolytic secondary battery according to a tenth aspect of the present invention comprises steps of preparing a positive electrode active material including a lithium-iron composite sulfide expressed in a composition formula LiₓFeS_{y} (2<x≦4, 0.5≦y≦3) by mechanically milling a mixture of at least either Fe or FeS and at least one material selected from a group of Li₂S, Li and S (S is not solely employed) and preparing a battery by a positive electrode containing the positive electrode active material, a negative electrode containing a negative electrode active material capable of occluding and emitting lithium and a nonaqueous electrolyte.

In the method of manufacturing a nonaqueous electrolytic secondary battery according to the tenth aspect, as hereinabove described, the mixture of at least either Fe or FeS and at least one material selected from the group of Li₂S, Li and S (S is not solely employed) is so mechanically milled that the lithium-iron composite sulfide expressed in the composition formula LiₓFeS_{y} (2<x≦4, 0.5≦y≦3) can be easily prepared. Further, the lithium-iron composite sulfide prepared by mechanical milling contains a large quantity of amorphous portions, whereby a battery exhibiting an excellent discharge characteristic also in initial discharge can be formed while the operating characteristic can be improved when the positive electrode containing the positive electrode active material including this lithium-iron composite oxide is applied to a nonaqueous electrolytic secondary battery.

In the aforementioned method of manufacturing a nonaqueous electrolytic secondary battery according to the tenth aspect, the step of preparing the positive electrode active material preferably includes a step of preparing the positive electrode active material including a lithium-iron composite sulfide expressed in a composition formula LiₓFeS_{y} (x≈4, y≈2) by mechanically milling a mixture obtained by mixing Fe and Li₂S with each other at a molar ratio of about 1:2. According to this structure, a negative electrode active material containing absolutely no lithium can be employed for the nonaqueous electrolytic secondary battery by setting the value x as x≈4. Therefore, a short in the battery resulting from formation of the so-called dendrite (arborescent lithium) and reduction of the operating cycle characteristic as well as the battery voltage can be suppressed, and the battery capacity (particularly the initial capacity) can be increased.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a test cell prepared for investigating the characteristics of each of positive electrodes of nonaqueous electrolytic secondary batteries according to Examples 1-1 to 1-4 and comparative example 1 respectively;

FIGS. 2 and 3 are graphs showing results of a charge/discharge test performed on the test cell corresponding to comparative example 1;

FIGS. 4 and 5 are graphs showing results of a charge/discharge test performed on the test cell corresponding to Example 1-1;

FIGS. 6 and 7 are graphs showing results of a charge/discharge test performed on the test cell corresponding to Example 1-2;

FIG. 8 is a graph showing results of a charge/discharge test performed on the test cell corresponding to Example 1-3;

FIG. 9 is a graph showing results of a charge/discharge test performed on the test cell corresponding to Example 1-4;

FIG. 10 is a graph showing an XRD spectrum of Li₂FeS₂ formed by performing heat treatment according to Example 1-1;

FIG. 11 is a graph showing an XRD spectrum of Li₂FeS₂ formed by performing mechanical milling according to Example 1-2;

FIG. 12 is a graph showing a charge curve at the first cycle and a discharge curve at the first cycle in an inventive cell A1;

FIG. 13 is a graph showing a charge curve at the first cycle and a discharge curve at the first cycle in an inventive cell A2;

FIG. 14 is a graph showing a charge curve at the first cycle and a discharge curve at the first cycle in an inventive cell A3; and

FIG. 15 is an X-ray analysis graph of a positive electrode active material employed for the inventive cell A1.

### DESCRIPTION OF THE PREFERRED EMBODIMENTS

Examples of the present invention are now specifically described.

### EXAMPLE 1

Lithium secondary batteries (nonaqueous electrolytic secondary batteries) according to Examples 1-1 to 1-4 and comparative example 1 were prepared and the characteristics thereof were compared with each other as follows:

### COMMON TO EXAMPLE 1-1 AND COMPARATIVE EXAMPLE 1)

[Preparation of Positive Electrode Active Material]

Li₂FeS₂ was prepared as a positive electrode active material by mixing Li₂S and FeS with each other at a molar ratio of 1:1 and thereafter heat-treating the mixture at 900° C. for 5 hours. When the mixture of Li₂S and FeS was subjected to measurement by TG-DATA (thermogravimetry-differential thermal analysis), reaction was observed at a temperature exceeding 300° C. Therefore, the heat treatment temperature is preferably set to at least 300° C.

### EXAMPLE 1-2

[Preparation of Positive Electrode Active Material]

Li₂FeS₂ was prepared as a positive electrode active material by mixing Li₂S and FeS with each other at a molar ratio of 1:1 and thereafter mechanically milling the mixture with a planetary ball mill at 300 rpm for 10 hours. The term “mechanical milling” indicates a treatment method capable of easily producing chemical reaction of a sample by applying mechanical energy to the sample with a planetary ball mill or the like. According to synthesis by this mechanical milling, it is possible to easily obtain a metastable amorphous material hardly obtainable according to synthesis by heat treatment.

### EXAMPLE 1-3

[Preparation of Positive Electrode Active Material]

Li₂FeS₂ was prepared as a positive electrode active material by mixing Li₂S and FeS with each other at a molar ratio of 2:1 and thereafter mechanically milling the mixture with a planetary ball mill at 300 rpm for 10 hours.

### EXAMPLE 1-4

[Preparation of Positive Electrode Active Material]

Li₂FeS₂ was prepared as a positive electrode active material by mixing Li₂S and FeS with each other at a molar ratio of 4:1 and thereafter mechanically milling the mixture with a planetary ball mill at 300 rpm for 10 hours.

### COMMON TO EAMPLES 1-1 TO 1-4 AND COMPARATIVE EXAMPLE 1

[Preparation of Positive Electrode]

A positive electrode was prepared by mixing Li₂FeS₂ (80 mass %) employed as the positive electrode active material according to each of Examples 1-1 to 1-4 and comparative example 1 prepared as described above, acetylene black (10 mass %) employed as a conductive agent and polytetrafluoroethylene (10 mass %) employed as a binder with each other, press-molding the mixture and drying the same under vacuum at 50° C.

### COMMON TO EXAMPLES 1-1 TO 1-4 AND COMPARATIVE EXAMPLE 1

[Preparation of Nonaqueous Electrolyte]

A nonaqueous electrolyte was prepared by adding lithium hexafluorophosphate (LiPF₆) employed as a solute to a mixed solvent obtained by mixing ethylene carbonate and diethyl carbonate with each other at a volume ratio of 3:7 so that the concentration was 1.0 mol/l.

[Preparation of Test Cell]

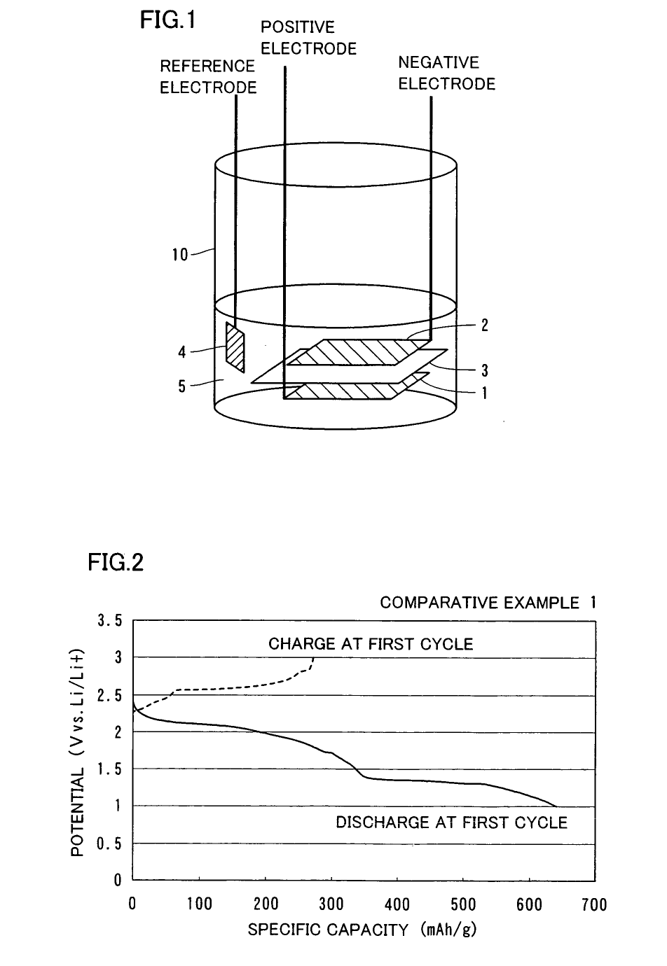

FIG. 1 is a perspective view showing a test cell prepared for investigating the characteristics of each of the positive electrodes of the nonaqueous electrolytic secondary batteries according to Examples 1-1 to 1-4 and comparative example 1. Referring to FIG. 1, a positive electrode 1 and a negative electrode 2 were arranged in a test cell vessel 10 to be opposed to each other through a separator 3. A reference electrode 4 was also arranged in the test cell vessel 10. The test cell was prepared by injecting a nonaqueous electrolyte 5 into the test cell vessel 10. The positive electrode 1 was prepared from each of the positive electrodes according to Examples 1-1 to 1-4 and comparative example 1 prepared in the aforementioned manner, while the negative electrode 2 and the reference electrode 4 were prepared from lithium metals. The nonaqueous electrolyte 5 was prepared from each of the nonaqueous electrolytes according to Examples 1-1 to 1-4 and comparative example 1 prepared in the aforementioned manner.

[Charge/Discharge Test]

The test cell corresponding to each of Examples 1-1 to 1-4 and comparative example 1 prepared in the aforementioned manner was subjected to a charge/discharge test. The test cell according to each of Examples 1-1 to 1-4 was charged up to a final charge potential of 3.0 V (vs. Li/Li⁺) with a charge current of 0.5 mA/cm², and thereafter discharged up to a final discharge potential of 1.5 V (vs. Li/Li⁺) with a discharge current of 0.5 mA/cm². On the other hand, the test cell according to comparative example 1 was charged up to a final charge potential of 3.0 V (vs. Li/Li⁺) with a charge current of 0.5 mA/cm², and thereafter discharged up to a final discharge potential of 1.0 V (vs. Li/Li⁺) with a discharge current of 0.5 mA/cm². The test cell according to each of Examples 1-1 to 1-4 was charged/discharged up to a 10^{th} operating cycle, while the test cell according to comparative example 1 was charged/discharged up to an 8^{th} operating cycle. FIGS. 2 to 9 shows the results.

More specifically, FIGS. 2, 4, 6, 8 and 9 show specific capacities at the first operating cycles in the test cells corresponding to comparative example 1 and Examples 1-1, 1-2, 1-3 and 1-4 respectively. The specific capacity is obtained as follows:
Specific capacity (mAh/g)=fed current (mAh)/mass (g) of positive electrode material

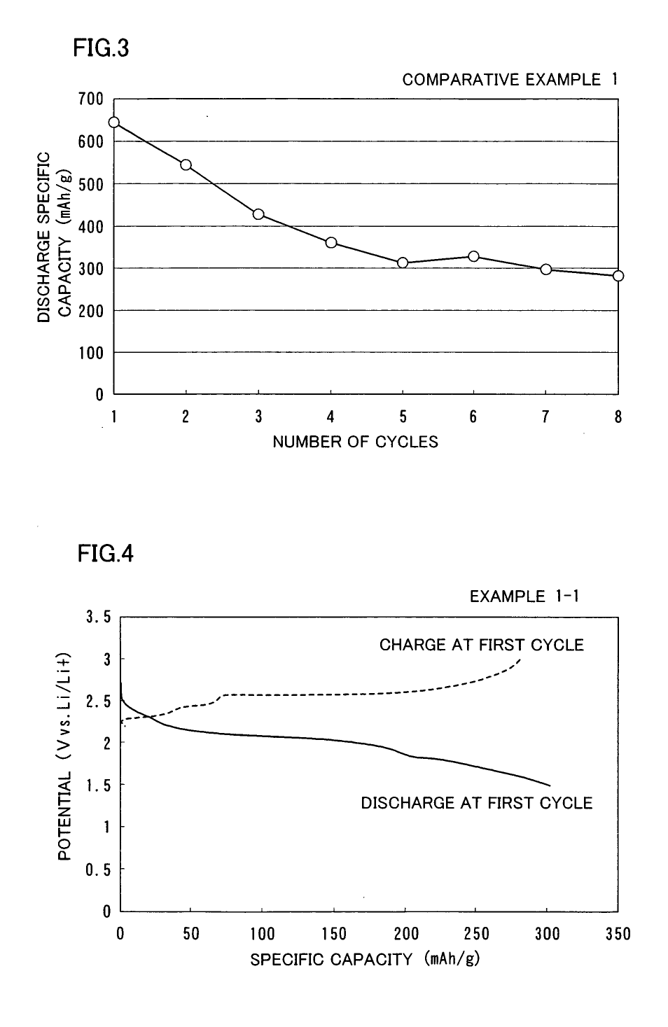

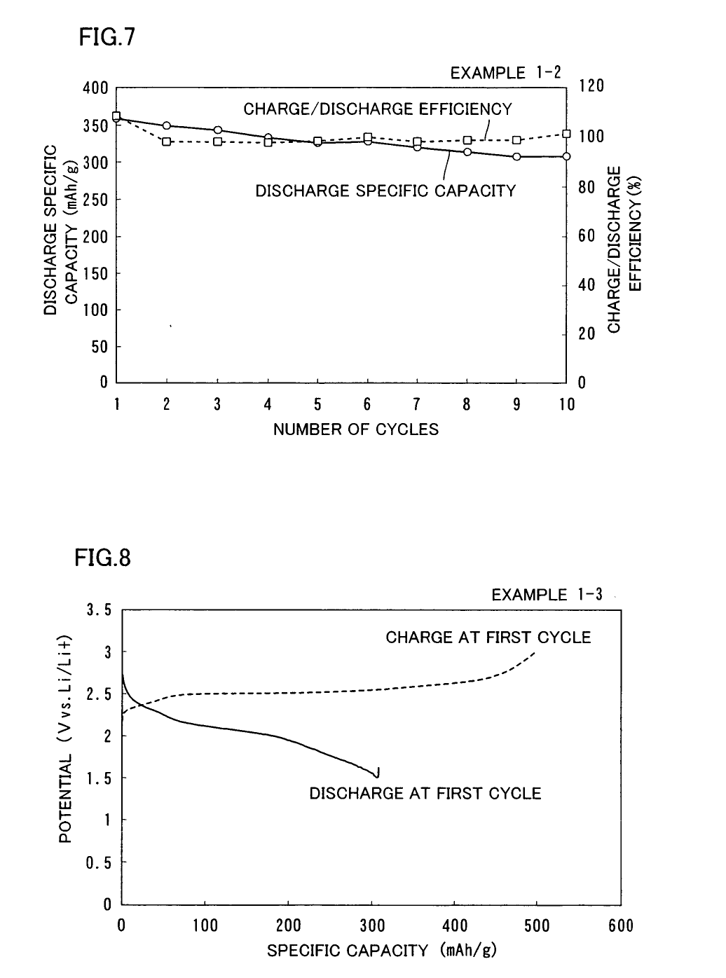

FIG. 3 shows the operating cycle characteristic of the test cell according to comparative example 1 up to the 8^{th} cycle, and FIGS. 5 and 7 show the operating cycle characteristics of the test cells according to Examples 1-1 and 1-2 up to the 10^{th} cycles respectively. Table 1 shows the charge/discharge characteristics of Examples 1-1 and 1-2 including the positive electrodes prepared from Li₂FeS₂ formed by heat treatment and mechanical milling 5 respectively. Table 2 shows the charge/discharge characteristics of Examples 1-2 to 1-4 including the positive electrodes prepared from Li₂FeS₂ formed by mechanical milling with various concentrations of Li₂S respectively.

TABLE 1

| | Initial | | | | |
|---|---|---|---|---|---|
| | Discharge | Initial | Discharge | | |
| | Specific | Charge/ | Specific | Charge/ | Capacity |
| | Capacity | Discharge | Capacity | Discharge | Retention |
| | (at First | Efficiency | at | Efficiency | Ratio |
| | Cycle) | (at First | 10^{th} Cycle | at 10^{th} | at 10^{th} |
| | mAh/g | Cycle) % | mAh/g | Cycle % | Cycle % |
| Heat | 302 | 108 | 247 | 103 | 82 |
| Treatment | | | | | |
| Li₂FeS₂ | | | | | |
| (Example 1) | | | | | |
| Mechanical | 359 | 109 | 307 | 101 | 86 |
| Milling | | | | | |
| Li₂FeS₂ | | | | | |
| (Example 2) | | | | | |

TABLE 2

| | Initial Discharge Specific | Capacity |
|---|---|---|
| | Capacity | Retention |
| | (at First Cycle) | Ratio at |
| | mAh/g | 10^{th} Cycle % |
| Li₂S:FeS = 1:1 mol (Example 2) | 359 | 86 |
| Li₂S:FeS = 2:1 mol (Example 3) | 308 | 45 |
| Li₂S:FeS = 4:1 mol (Example 4) | 86 | 12 |

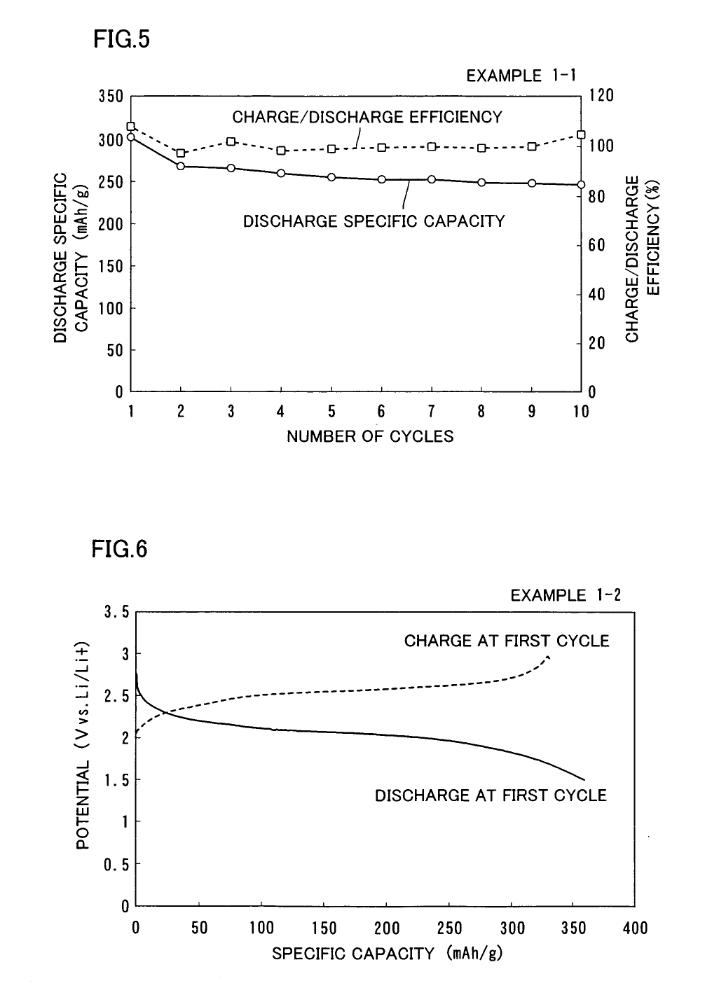

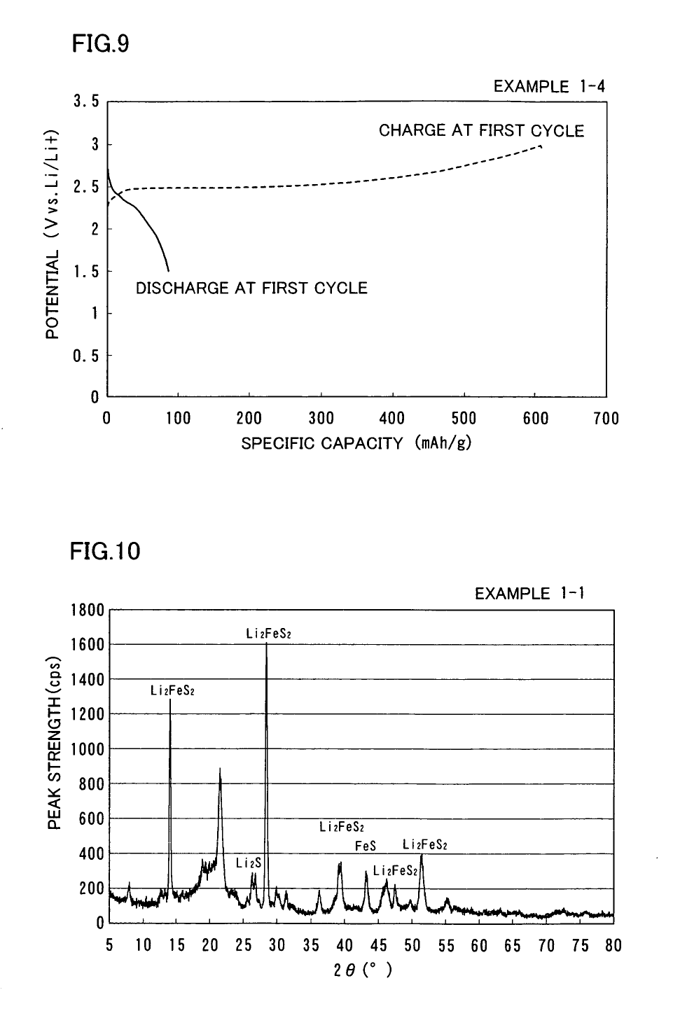

In comparative example 1 carried out with the final discharge potential set to 1.0 V (vs. Li/Li⁺), the charge and discharge specific capacities at the 1^{st} cycle were 273 mAh/g and 642 mAh/g respectively, as shown in FIG. 2. Referring to FIG. 3, the capacity retention ratio after the 8^{th} cycle (discharge specific capacity at the 8^{th} cycle/discharge specific capacity at the 1^{st} cycle×100) was 54% in comparative example 1. Thus, it has been proved that the capacity retention ratio was reduced in comparative example 1. In Example 1-1 carried out with the final discharge potential set to 1.5 V (vs. Li/Li⁺), on the other hand, the discharge specific capacity at the 1^{st} cycle was 302 mAh/g and the capacity retention ratio after the 10^{th} cycle was 82%, as shown in Table 1 and FIGS. 4 and 5. Thus, it has been proved that a higher capacity retention ratio was obtained according to Example 1-1 as compared with comparative example 1. In Example 1-2, the discharge specific capacity at the 1^{st} cycle was 359 mAh/g and the capacity retention ratio after the 10^{th} cycle was 86%, as shown in Table 1 and FIGS. 6 and 7. In Example 1-3, the discharge specific capacity at the 1ₛₜ cycle was 308 mAh/g and the capacity retention ratio after the 10^{th} cycle was 45%, as shown in Table 2 and FIG. 8. In Example 1-4, the discharge specific capacity at the 1^{st} cycle was 86 mAh/g and the capacity retention ratio after the 10^{th} cycle was 12%, as shown in Table 2 and FIG. 9.

As hereinabove described, a higher capacity retention ratio can be obtained in Example 1 carried out with the final discharge potential set to 1.5 V as compared with comparative example 1 carried out with the final discharge potential set to 1.0 V, whereby the operating cycle characteristic of the former can be further improved as compared with the latter. This is conceivably because the final discharge potential of the positive electrode is so set to 1.5 V (vs. Li/Li⁺) in Example 1-1 that Li₂FeS₂ can be effectively prevented from separating into Fe hardly allowing charge reaction and the insulator Li₂S due to the reaction of the above formula (2). In other words, not the reaction of the above formula (2) but that of the above formula (1) is produced in Example 1-1 carried out with the final discharge potential of the positive electrode set to 1.5 V (vs. Li/Li⁺). Thus, charge reaction can be so easily produced in Example 1-1 that the operating cycle characteristic of the positive electrode can be improved. In comparative example 1 carried out with the final discharge potential set to 1.0 V (vs. Li/Li⁺), on the other hand, Li₂FeS₂ is separated into Fe hardly allowing charge reaction and the insulator Li₂S at this final discharge potential due to the reaction of the above formula (2). Thus, charge reaction is so hardly allowed in comparative example 1 that the operating cycle characteristic thereof is reduced as a result.

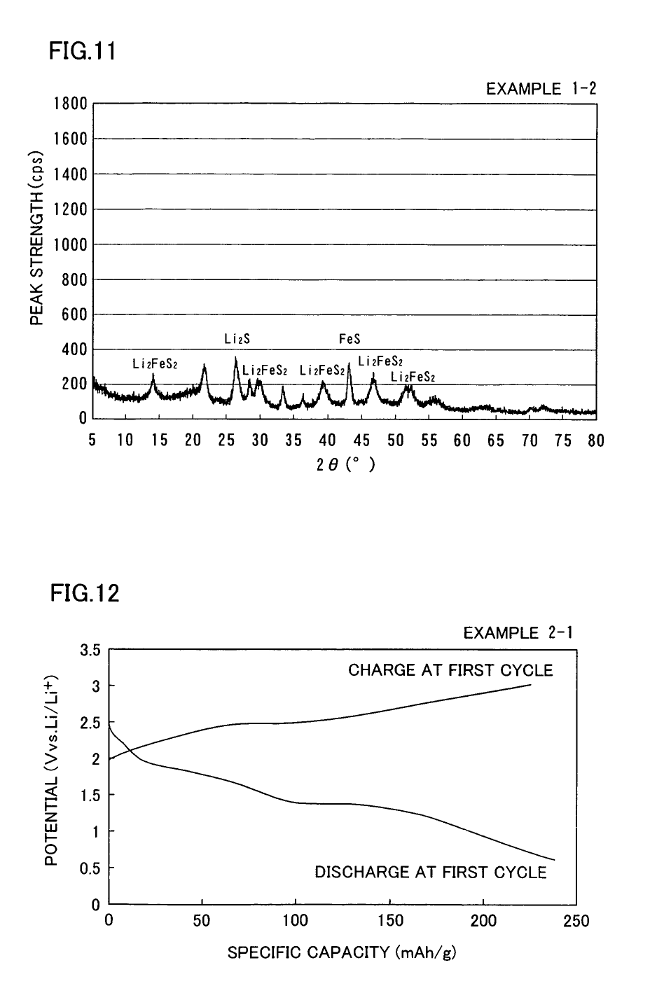

From the aforementioned results of Examples 1-1 and 1-2, it has been proved that Example 1-2 employing Li₂FeS₂ formed by mechanical milling exhibits a higher discharge specific capacity at the 1^{st} cycle and a higher capacity retention ratio after the 10^{th} cycle than Example 1-1 employing Li₂FeS₂ formed by heat treatment. Results of measurement performed on the positive electrode active materials of Li₂FeS₂ prepared according to Examples 1-1 and 1-2 by XRD (X-ray diffraction) are now described with reference to FIGS. 10 and 11. Referring to FIGS. 10 and 11, it has been proved that Li₂FeS₂ prepared by mechanical milling according to Example 1-2exhibited lower peak strength than Li₂FeS₂ prepared by heat treatment according to Example 1-1. Thus, it has been recognized that Li₂FeS₂ prepared by mechanical milling according to Example 1-2 has an approximately amorphous (substantially amorphous) structure. As understood from these results, it is conceivably possible to improve the operating cycle characteristic of the positive electrode by employing substantially amorphous Li₂FeS₂ formed by mechanically milling a mixture of Li₂S and FeS.

From the aforementioned results of Examples 1-2 to 1-4, it has also been proved that Example 1-2 employing Li₂FeS₂ formed by mixing Li₂S and FeS with each other at the molar ratio of 1:1 and mechanically milling the mixture exhibits a higher discharge specific capacity at the 1^{st} cycle and a higher capacity retention ratio after the 10^{th} cycle than Example 1-3 employing Li₂FeS₂ formed by mixing Li₂S and FeS with each other at the molar ratio of 2:1 and mechanically milling the mixture and Example 1-4 employing Li₂FeS₂ formed by mixing Li₂S and FeS with each other at the molar ratio of 4:1 and mechanically milling the mixture. As understood from these results, it is conceivably possible to obtain Li₂FeS₂ exhibiting a more excellent operating cycle characteristic by mixing Li₂S and FeS with each other at the molar ratio of 1:1 and mechanically milling the mixture. Therefore, the mixing ratio for Li₂S and FeS subjected to mechanical milling is preferably set to the molar ratio of 1:1.

### EXAMPLE 2

Lithium secondary batteries (nonaqueous electrolytic secondary batteries) according to Examples 2-1 to 2-3 and comparative example 2 were prepared and the characteristics thereof were compared with each other as follows:

[Preparation of Positive Electrode]

A lithium-iron composite sulfide expressed in a composition formula LiₓFeS_{y} (x≈4, y≈2) employed as a positive electrode active material was prepared by mixing Fe and Li₂S with each other under an Ar gas atmosphere at a molar ratio of 1:2 and mechanically milling the mixture with a planetary ball mill at 300 rpm for 10 hours.

Then, a positive electrode 1 was prepared by mixing 80 mass % of the aforementioned lithium-iron composite sulfide, 10 mass % of acetylene black employed as a conductive agent and 10 mass % of polyvinylidene fluoride employed as a binder with each other, thereafter press-molding the mixture and drying the same under a vacuum atmosphere at 50° C.

[Preparation of Negative Electrode]

A negative electrode 2 was prepared by cutting a lithium metal plate into a prescribed size.

[Preparation of Nonaqueous Electrolyte]

A nonaqueous electrolyte 5 was prepared by dissolving lithium hexafluorophosphate (LiPF₆) employed as a solute to an electrolyte, obtained by mixing ethylene carbonate and diethyl carbonate with each other at a volume ratio of 30:70, at a ratio of 1.0 mol/l.

[Preparation of Test Cell]

Each test cell was prepared in a structure similar to that of the test cell according to Example 1 shown in FIG. 1 with the aforementioned positive electrode 1, the aforementioned negative electrode 2 and the aforementioned nonaqueous electrolyte 5, a separator 3, a reference electrode 4 of a lithium metal and a test cell vessel 10.

### EXAMPLE 2-1

A test cell of Example 2-1 was prepared similarly to the test cell described above. This cell is hereinafter referred to as an inventive cell A1.

### EXAMPLE 2-2

A test cell of Example 2-2 was prepared similarly to that of the aforementioned Example 2-1 except that Fe and Li₂S were mixed with each other at a molar ratio of 1:1.

This cell is hereinafter referred to as an inventive cell A2.

### EXAMPLE 2-3

A test cell of Example 2-3 was prepared similarly to that of the aforementioned Example 2-1 except that a negative electrode of carbon was employed.

This cell is hereinafter referred to as an inventive cell A3.

### Comparative Example 2

A test cell of comparative example 2 was prepared similarly to that of the aforementioned Example 2-1 except that Fe and Li₂S were pulverized/mixed with each other in a mortar so that the molar ratio therebetween was 1:2.

This cell is hereinafter referred to as a comparative cell X.

[Charge/Discharge Test]

The aforementioned inventive cells A1, A2 and A3 and the comparative cell X were subjected to a charge/discharge test under the following conditions:

Charged up to a final charge potential of 3.0 V (vs. Li/Li⁺) with a charge current of 0.5 mA/cm²; and

discharged up to a final discharge potential of 0.5 V (vs. Li/Li⁺) with a discharge current of 0.5 mA/cm².

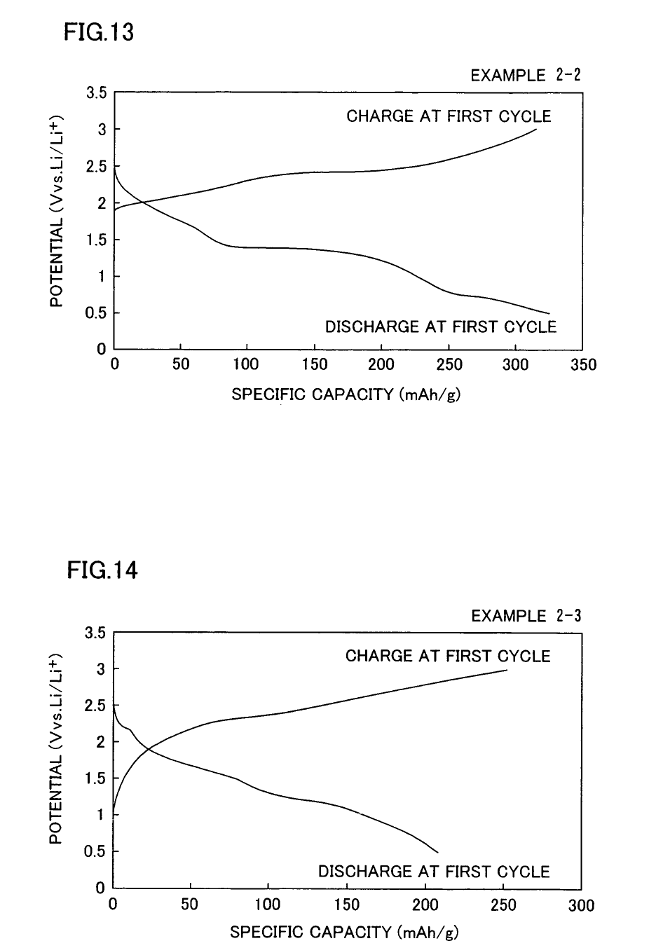

Table 3 shows specific capacities at 1^{st} cycles (may also be referred to as initial discharge specific capacities) and charge/discharge efficiency at the 1^{st} cycles (may also be referred to as initial charge/discharge efficiency) of the inventive cells A1 and A2 and the comparative cell X. FIGS. 12, 13 and 14 show results of charge and discharge characteristics at the 1^{st} cycles in the inventive cells A1, A2 and A3 respectively.

TABLE 3

| | | | Initial | |
|---|---|---|---|---|
| | | | Discharge | Initial Charge/ |
| | Mechanical | Fe:Li₂S | Capacity | Discharge |
| | Milling | (mol) | (mAh/g) | Efficiency (%) |
| Inventive Cell | Yes | 1:2 | 240 | 106 |
| A1 | | | | |
| Inventive Cell | Yes | 1:1 | 324 | 104 |
| A2 | | | | |
| Comparative | No | 1:2 | — | — |
| Cell X | | | | |

As clearly understood from Table 3, the comparative cell X was absolutely not chargeable/dischargeable, while the inventive cells A1 and A2 exhibited initial discharge specific capacities of 240 mAh/g and 324 mAh/g respectively. It has also been recognized that both of the inventive cells A1 and A2 exhibited initial charge/discharge efficiency of at least 100%. These results were conceivably brought about for the following reason:

While the material prepared by simply pulverizing/mixing Fe and Li₂S with each other in a mortar for the comparative cell X cannot serve as a positive electrode active material, the mixture of Fe and Li₂S mechanically milled in each of the inventive cells A1 and A2 easily produces chemical reaction for providing a metastable amorphous material (lithium-iron composite sulfide having a composition close to a composition formula Li₄FeS₂) due to mechanical energy applied thereto.

While the theoretical capacity of the positive electrode active material expressed in the composition formula Li₄FeS₂ is 724 mAh/g, the initial discharge specific capacities of the inventive cells A1 and A2 were only 240 mAh/g and 324 mAh/g respectively, conceivably for the following reason:

Fe, one of the starting materials, conceivably contains a large quantity of iron oxide, which does not react with Li₂S but remains in the positive electrode active material as an impurity. The quantity of the actually formed lithium-iron composite sulfide is therefore conceivably remarkably reduced as compared with the theoretical quantity (maximized when Fe and Li₂S are at the molar ratio of 1:2 as in the inventive cell A1).

Further, the inventive cell A2 exhibited a larger initial discharge specific capacity than the inventive cell A1 conceivably for the following reason: While the mixture of Fe and Li₂S was mechanically milled with the molar ratio of 1:2 in the inventive cell A1, the mixture of Fe and Li₂S was mechanically milled with the molar ratio of 1:1, i.e., with a larger relative quantity of Fe in the inventive cell A2. The inventive cell A2 was conceivably therefore less relatively influenced by the presence of iron oxide, with formation of a larger quantity of lithium-iron composite sulfide. In order to investigate this, analysis through an X-ray diffractometer was performed as described later.

It is clearly recognized from FIGS. 12 to 14 that the cell employing the negative electrode of carbon could also obtain charge/discharge capacity substantially similar to that of the cell employing the negative electrode of the lithium metal.

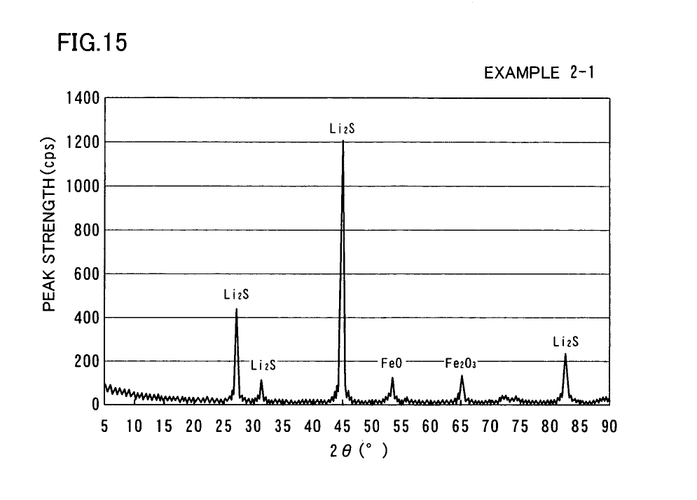

FIG. 15 shows results of X-ray diffraction of the positive electrode active material employed for the inventive cell A1 investigated through an X-ray diffractometer (XRD).

As clearly understood from FIG. 15, peaks of Li₂S and iron oxide were confirmed to prove that Fe, one of the starting materials, contained a large quantity of iron oxide not reacting with Li₂S. No other peaks were confirmed except those of Li₂S and iron oxide but amorphous broad portions were conceivably present, and hence the formed lithium-iron composite sulfide was conceivably amorphous. The amorphous lithium-iron composite sulfide conceivably resulted from reaction shown in the following formula (6):
Fe+2Li₂S→Li₄FeS₂ (6)

Although the present invention has been described and illustrated in detail, it is clearly understood that the same is by way of illustration and example only and is not to be taken by way of limitation, the spirit and scope of the present invention being limited only by the terms of the appended claims.

For example, while the final discharge potential was set to 1.5 V (vs. Li/Li⁺) in the aforementioned Example 1, the present invention is not restricted to this but the final discharge potential may alternatively be set to another level so far as the reaction of the above formula (2) is not allowed to separate Li₂FeS₂ into Fe hardly allowing charge reaction and the insulator Li₂S. In other words, the final discharge potential may be set to a prescribed level allowing not the reaction of the above formula (2) but the reaction of the above formula (1). For example, the final discharge potential may be set to a prescribed level of at least 1.5 V (vs. Li/Li⁺).

While Li₂FeS₂ was employed as the positive electrode active material in the aforementioned Example 1, the present invention is not restricted to this but any material decided by the composition formula LiₓFeS_{y} (0≦x≦4, 0.5≦y≦3) can be employed as the positive electrode active material. In particular, Li₂FeS₂, FeS or FeS₂ is easy to synthesize and hence easily utilizable as the positive electrode active material. Particularly when Li₂FeS₂ containing Li⁺necessary for charge/discharge reaction itself is used as the positive electrode active material, a carbon material or a silicon material containing no Li⁺can be used for the negative electrode. Further, a positive electrode employing LiₓFeS_{y} (2<x≦4, 0.5≦y≦3: e.g. x≈4, y≈2) as a positive electrode active material may be employed in place of the positive electrode employing Li₂FeS₂ as the positive electrode active material in Example 1, while the final discharge potential of the positive electrode may be set to a prescribed level exceeding the minimum potential allowing the discharge reaction FeS_{y}+xLi⁺→LiₓFeS_{y}. In addition, Fe in the above composition formula LiₓFeS_{y} may alternatively be replaced with another transition metal such as Mn, Co, Ni, Cu or Mo.

While polytetrafluoroethylene or polyvinilidene fluoride was employed as the binder added to the positive electrode in each of the aforementioned Examples 1 and 2, the present invention is not restricted to this but an effect similar to the above can be attained also when at least one material selected from a group of polyethylene oxide, polyvinyl acetate, polymethacrylate, polyacrylate, polyacrylonitrile, polyvinyl alcohol, styrene-butadiene rubber and carboxymethyl cellulose is employed.

While the binder of polytetrafluoroethylene added to the positive electrode was mixed in the ratio of 10 mass % in the aforementioned Example 1, the present invention is not restricted to this but the ratio of the mixed binder may be at least 0.1 mass % and not more than 30 mass %. The ratio of the binder is more preferably at least 0.1 mass % and not more than 20 mass %, and further preferably at least 0.1 mass % and not more than 10 mass %.

While acetylene black was employed as the conductive agent added to the positive electrode in each of the aforementioned Examples 1 and 2, the present invention is not restricted to this but the conductive agent added to the positive electrode may alternatively be prepared from a conductive carbon material or the like other than acetylene black. In this case, the ratio of the conductive agent added to the positive electrode may be at least 0 mass % and not more than 30 mass %. The ratio of the conductive material is more preferably at least 0 mass % and not more than 20 mass %, and further preferably at least 0 mass % and not more than 10 mass %.

While the nonaqueous electrolyte contained the mixed solvent of ethylene carbonate and diethyl carbonate in each of the aforementioned Examples 1 and 2, the present invention is not restricted to this but a solvent other than the mixed solvent of ethylene carbonate and diethyl carbonate may alternatively be employed so far as the same can be used as the solvent for the nonaqueous electrolytic secondary battery. For example, cyclic carbonic acid ester, chain carbonic acid ester, ester, cyclic ether, chain ether, nitrile or amide can be listed as the solvent other than the mixed solvent of ethylene carbonate and diethyl carbonate. Propylene carbonate or butylene carbonate can be listed as the cyclic carbonic acid ester, for example. Further, cyclic carbonic acid ester having partially or entirely fluoridated hydrogen groups such as trifluoropropylene carbonate or fluoroethyl carbonate, for example, can also be used. Dimethyl carbonate, ethylmethyl carbonate, methylpropyl carbonate, ethylpropyl carbonate or methylisopropyl carbonate can be listed as chain carbonic acid ester, for example. Further, cyclic carbonic acid ester having partially or entirely fluoridated hydrogen groups can also be used.

Methyl acetate, ethyl acetate, propyl acetate, methyl propionate, ethyl propionate or γ-butyrolactone can be listed as ester. 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol or crown ether can be listed as cyclic ether, for example. 1,2,-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether or tetraethylene glycol demthyl can be listed as chain ether, for example. Acetonitrile can be listed as nitrile, for example. Dimethyl formamide can be listed as amide, for example.

While the nonaqueous electrolyte in which lithium hexafluorophosphate (LiPF₆) was dissolved as the solute (electrolytic salt) was employed in each of the aforementioned Examples 1 and 2, the present invention is not restricted to this but a nonaqueous electrolyte in which a solute other than lithium hexafluorophosphate is dissolved may alternatively be employed. For example, lithium difluoro(oxalate)borate expressed in the following chemical formula 1, LiAsF₆, LiBF₄, LiCF₃SO₃, LiC₄F₉SO₃, LiN(CF₃SO₂)₂ or LiN(C₂F₅SO₂)₂ can be listed as the solute other than lithium hexafluorophosphate, for example. A mixture obtained by combining at least two solutes selected from the group of the aforementioned solutes may also be employed. This solute (electrolytic salt) is preferably dissolved in the aforementioned nonaqueous solvent in a concentration of 0.1 to 1.5 mol/l, and more preferably in a concentration of 0.5 to 1.5 mol/l.

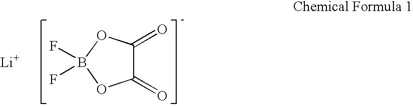

While the negative electrode was prepared from the lithium metal in each of the aforementioned Examples 1 and 2, the present invention is not restricted to this but a material other than the lithium metal may alternatively be employed as the negative electrode active material so far as the same can occlude and emit lithium. For example, a carbon material such as a lithium alloy or graphite or silicon can be listed as the material employable as the negative electrode active material. When a negative electrode containing a negative electrode active material of silicon (Si) having high capacity is employed, a nonaqueous electrolytic battery having high energy density can be obtained.

While the quantity of the lithium-iron composite sulfide was increased by increasing the relative ratio of Fe in the aforementioned Example 2, the present invention is not restricted to this method but the quantity of the lithium-iron composite sulfide can alternatively be increased by removing iron oxide contained in the starting materials. Iron oxide may be removed by reducing the starting materials with hydrogen or the like, for example.

While Fe and Li₂S were employed as the starting materials for forming the lithium-iron composite sulfide in the aforementioned Example 2, the present invention is not restricted to this but FeS, Li and S can alternatively be employed as the starting materials.

While mechanical milling was performed in the Ar gas atmosphere in the aforementioned Example 2, the present invention is not restricted to this but mechanical milling may alternatively be performed under a treatment condition other than the Ar gas atmosphere. In order to prevent oxidation of Fe, however, mechanical milling is preferably performed in an inert gas atmosphere of Ar gas or the like.

1. A nonaqueous electrolytic secondary battery comprising:
a positive electrode containing a positive electrode active material including LiₓFeS₂ (0≦x≦4);
a negative electrode containing a material occluding and emitting lithium ions; and
a nonaqueous electrolyte, wherein
the final discharge potential of said positive electrode is set to a prescribed level exceeding the minimum potential allowing discharge reaction expressed in the following formula (3):
FeS₂+xLi⁺→LiₓFeS₂ (3)

2. The nonaqueous electrolytic secondary battery according to claim 1, wherein
LiₓFeS₂ (0≦x≦4) included in said positive electrode active material is Li₂FeS₂, and
the final discharge potential of said positive electrode is set to a prescribed level exceeding the minimum potential allowing discharge reaction expressed in the following formula (4):
FeS₂+2Li⁺→Li₂FeS₂ (4)

3. The nonaqueous electrolytic secondary battery according to claim 2, wherein
the final discharge potential of said positive electrode is set to a level of at least about 1.5 V (vs. Li/Li⁺).

4. The nonaqueous electrolytic secondary battery according to claim 1, wherein
LiₓFeS₂ forming said positive electrode active material is substantially amorphous.

5. A nonaqueous electrolytic secondary battery comprising:
a positive electrode containing a positive electrode active material including LiₓFeS₂ (0≦x≦4);
a negative electrode containing a material occluding and emitting lithium ions; and
a nonaqueous electrolyte, wherein
the final discharge potential of said positive electrode is set to a level of at least about 1.5 V (vs. Li/Li⁺).

6. The nonaqueous electrolytic secondary battery according to claim 5, wherein
LiₓFeS₂ forming said positive electrode active material is substantially amorphous.

7. A nonaqueous electrolytic secondary battery comprising:
a positive electrode containing a positive electrode active material including LiₓFeS_{y} (0≦x≦4, 0.5≦y≦3);
a negative electrode containing a material occluding and emitting lithium ions; and
a nonaqueous electrolyte, wherein
the final discharge potential of said positive electrode is set to a prescribed level exceeding the minimum potential allowing discharge reaction expressed in the following formula (5):
FeS_{y}+xLi⁺→LiₓFeS_{y} (5)

8. A method of manufacturing a nonaqueous electrolytic secondary battery comprising a positive electrode containing a positive electrode active material including LiₓFeS₂ (0≦x≦4), a negative electrode containing a material occluding and emitting lithium ions and a nonaqueous electrolyte, wherein the final discharge potential of said positive electrode is set to a prescribed level exceeding the minimum potential allowing discharge reaction expressed in the following formula (3), comprising steps of:
forming said positive electrode containing said positive electrode active material including LiₓFeS₂ by heat-treating a mixture of Li₂S and FeS_{(2-x/2)} (0≦x≦4); and
forming said negative electrode containing said material occluding and emitting lithium ions:
FeS₂+xLi⁺→LiₓFeS₂ (3)

9. A method of manufacturing a nonaqueous electrolytic secondary battery comprising a positive electrode containing a positive electrode active material including LiₓFeS₂ (0≦x≦4), a negative electrode containing a material occluding and emitting lithium ions and a nonaqueous electrolyte, comprising steps of:
forming said positive electrode containing said positive electrode active material including substantially amorphous said LiₓFeS₂ by mechanically milling a mixture of Li₂S and FeS_{(2x/2)} (0≦x≦4); and
forming said negative electrode containing said material occluding and emitting lithium ions.

10. A method of manufacturing a nonaqueous electrolytic secondary battery comprising a positive electrode containing a positive electrode active material including LiₓFeS₂ (0≦x≦4), a negative electrode containing a material occluding and emitting lithium ions and a nonaqueous electrolyte, wherein the final discharge potential of said positive electrode is set to a prescribed level exceeding the minimum potential allowing discharge reaction expressed in the following formula (3), comprising steps of:
forming said positive electrode containing said positive electrode active material including substantially amorphous said LiₓFeS₂ by mechanically milling a mixture of Li₂S and FeS_{(2-x/2)} (0≦x≦4); and
forming said negative electrode containing said material occluding and emitting lithium ions:
FeS₂+xLi⁺→LiₓFeS₂ (3)

11. A positive electrode for a nonaqueous electrolytic secondary battery, containing a positive electrode active material including a lithium-iron composite sulfide having a composition expressed in a composition formula LiₓFeS_{y} (2<x≦4, 0. 5≦y≦3) before initial charge.

12. The positive electrode for a nonaqueous electrolytic secondary battery according to claim 11, wherein
x≈4 and y≈2 in said lithium-iron composite sulfide expressed as LiₓFeS_{y}.

13. The positive electrode for a nonaqueous electrolytic secondary battery according to claim 11, wherein
said positive electrode active material contains an amorphous portion before initial charge.

14. A method of manufacturing a positive electrode for a nonaqueous electrolytic secondary battery, comprising steps of:
preparing a mixture of at least either Fe or FeS and at least one material selected from a group of Li₂S, Li and S (S is not solely employed); and
preparing a positive electrode active material including a lithium-iron composite sulfide expressed in a composition formula LiₓFeS_{y} (2<x≦4, 0.5≦y≦3) by mechanically milling said mixture.

15. The method of manufacturing a positive electrode for a nonaqueous electrolytic secondary battery according to claim 14, wherein
said step of preparing said mixture includes a step of mixing said Fe and said Li₂S with each other at a molar ratio of about 1:2, and
said step of preparing said positive electrode active material includes a step of preparing said positive electrode active material including said lithium-iron composite sulfide expressed in said composition formula LiₓFeS_{y} (x≈4, y≈2) by mechanically milling said mixture.

16. A nonaqueous electrolytic secondary battery comprising:
a positive electrode containing a positive electrode active material including a lithium-iron composite sulfide having a composition expressed in a composition formula LiₓFeS_{y} (2<x≦4, 0.5≦y≦3) before initial charge;
a negative electrode containing a negative electrode active material capable of occluding and emitting lithium; and
a nonaqueous electrolyte.

17. The nonaqueous electrolytic secondary battery according to claim 16, wherein
x≈4 and y≈2 in said lithium-iron composite sulfide expressed as LiₓFeS_{y}.

18. The nonaqueous electrolytic secondary battery according to claim 16, wherein
said positive electrode active material contains an amorphous portion before initial charge.

19. The nonaqueous electrolytic secondary battery according to claim 16, wherein
said negative electrode active material contains either a carbon material or a silicon material.

20. A method of manufacturing a nonaqueous electrolytic secondary battery, comprising steps of:
preparing a positive electrode active material including a lithium-iron composite sulfide expressed in a composition formula LiₓFeS_{y} (2<x≦4, 0.5≦y≦3) by mechanically milling a mixture of at least either Fe or FeS and at least one material selected from a group of Li₂S, Li and S (S is not solely employed); and
preparing a battery by a positive electrode containing said positive electrode active material, a negative electrode containing a negative electrode active material capable of occluding and emitting lithium and a nonaqueous electrolyte.

21. The method of manufacturing a nonaqueous electrolytic secondary battery according to claim 20, wherein
said step of preparing said positive electrode active material includes a step of preparing said positive electrode active material including a lithium-iron composite sulfide expressed in a composition formula LiₓFeS_{y} (x≈4, y≈2) by mechanically milling a mixture obtained by mixing said Fe and said Li₂S with each other at a molar ratio of about 1:2.
